(19) United States
(12) Patent Application Publication
(10) Pub. No.: US 2007/0043153 A1
(43) Pub. Date: Feb. 22, 2007

(54) Adhesion promoters for plastisols

(75) Inventors: Alfred Kruse, Dortmund (DE); Christa Broll, Castrop-Rauxel (DE); Jorg Volle, Selm-Bork (DE)

Correspondence Address: Huntsman Corporation;Legal Department, 10003 Woodloch Forest Drive, The Woodlands, TX, 77380, US

(73) Assignee: Huntsman Advanced Materials Americas Inc., The Woodlands, TX (US)

(21) Appl. No.: 10/564,068

(22) PCT Filed: Jul. 8, 2004
(86) PCT No.: PCT/EP04/51421

§ 371 Date: Jun. 5, 2006

(30) Foreign Application Priority Data
Jul. 11, 2003 (DE) 103 31 520.9

(51) Int. Cl. C08K 5/06

(52) U.S. Cl. 524/376

(57) ABSTRACT

The invention relates to adhesion promoters for plastisols based on polyaminoamides, characterized in that the adhesion promoter comprises not only a polyaminoamide but also at least 10% by weight, and at most 60% by weight, based on the total amount of adhesion promoter, of ethyldiglycol (ethyl Carbitol), and to a process for the production of coatings and adhesive bonds for materials, and also to plastisols in which these adhesion promoters are used concomitantly.

The invention relates to adhesion promoters based on polyaminoamides, comprising ethyidiglycol, and also to the use of these adhesion promoters for improving adhesion of PVC plastisols.

Plastisols are widely used for protecting metallic surfaces from corrosion. In particular in the automotive sector, plastisols are used for the waterproofing, bonding and sealing of seams and joints, and for protecting external surfaces, such as underbodies and sills.

These applications mostly use plastisols based on PVC polymers or on PVC copolymers. These plastisols are composed of fine polymer particles which have been dispersed in a non-volatile plasticizer. At room temperature, the polymer particles are insoluble in the liquid phase. At a higher temperature (gelling temperature), the polymer particles dissolve in the plasticizer. On cooling, the homogeneous solution hardens to give a flexible or rigid coating. The main methods used to apply these coatings to the materials to be protected are brushing, rolling or spraying.

The formulation of plasticized polyvinyl chloride coating compositions (plastisols), and their preparation and use is extensively described in: Krekeler/Wick, Kunststoff-Handbuch [Plastics Handbook] (1963), Volume 11, Part 1, pp. 396 ff.

A significant criterion for the quality of plastisols applied in this way is their adhesion to the coated material. Relatively low adhesion of the protective layer increases the risk of penetration of aggressive fluids. For example, water can migrate under the coating and corrode the metal. This becomes increasingly possible as the adhesion of the protective film to the metal becomes lower. To increase the adhesion of these coatings, therefore, industry adds adhesion-improving additives to the plasticized polyvinyl chloride. The function of the adhesion promoters is to bring about lasting adhesion to the surfaces of commonly encountered materials, such as non-degreased untreated steel, galvanised metal sheet or tin-coated metal sheet, electrocoated metal sheet, etc.

There are previously-developed adhesion promoters for PVC plastisols. Examples of these adhesion promoters are polyamines, epoxy resins, capped isocyanates, organofunctional silanes, and esters of acrylic or methacrylic acid.

In most cases, the adhesion promoters used comprise polyaminoamides containing imidazoline groups. These give good adhesion to the substrate, even if the concentrations in the plastisol are relatively small. These polyaminoamides are prepared from what are known as polymerized fatty acids and an excess of polyethylene polyamines, by polycondensation. The expression polymerized fatty acids encompasses polymerized fatty acids prepared from unsaturated, naturally occurring or synthetic, monobasic, aliphatic acids having from 12 to 22 carbon atoms, preferably 18 carbon atoms. The fatty acids may be polymerized by a well-known process, for example as in DE 25 06 211 A1. These adhesion promoters are described by way of example in DE 26 54 871 A1 and in DE 32 01 265 A1. DE 44 00 509 A1 describes plastisol compositions in which the addition of secondary adhesion promoters in the form of trihydric or higher-functionality aliphatic alcohols and/or alkanolamines, in addition to the conventional adhesion promoters based on polyaminoamides, to PVC plastisols improves their adhesion properties, in particular on sheets coated by a cataphoretic process. In the experimental section of that specification, glycerol is used as secondary adhesion promoter. However, these secondary adhesion promoters have to be added in addition to the primary polyaminoamide adhesion promoters, the amount of which incorporated Into the plastisol is usually about 1% by weight (based on the total amount of plastisol). The viscosity of the polyaminoamides used is moreover generally very high, and incorporation into the plastisol is therefore rendered difficult.

In order to lower the viscosity and thus provide good processability of the adhesion promoter, e.g. for the mixing of the adhesion promoter into the plastisol, and also to lower the price of these adhesion promoters, the adhesion promoters, which are generally of very high viscosity, are often formulated with plasticizers. However, plasticizers have an adverse effect on the adhesion of the PVC plastisol to the substrate in most cases. Plasticizers often used are phthalic esters, e.g. dibutyl phthalate, dioctyl phthalate or dinonyl phthalate. One adverse effect which has been observed is their low effectiveness in diluting the adhesion promoter. Relatively high amounts of these phthalates have to be used if sufficient processability is to be provided.

However, larger amounts of these plasticizers have an adverse effect on adhesion to the substrate. In addition, dialkyl phthalates used as plasticizers in adhesion promoters bring about a rise in viscosity of the adhesion promoter over the course of time, this being explicable via cleavage of the ester and reaction with the free amine groups in the polyaminoamide/imidazoline. The usefulness of these adhesion promoters is therefore subject to a time limit, because after some time incompatibility arises, and finally gelling occurs. In addition, the toxicological risks posed by the dialkyl phthalates class of product have recently caused their use to be criticized. DE 694 02 959 T2 claims a process for the preparation of specific polyamide resins which, according to Claim 9, comprise dioctyl phthalate, benzyl alcohol, and diisopropyinaphthalene as plasticizers. EP 0 658 574 A1 describes the use of amidoamines, imidoamines and ester amines based on

a) copolymers of monounsaturated carboxylic acids and ethylenically unsaturated compounds and

b) polyamines as adhesion promoters, likewise using the abovementioned compounds as plasticizers. However, as the proportion in the adhesion promoter rises, the use of these plasticizers again leads to impairment of adhesion of the plastisol to the substrate.

Finally, EP 0 263 053 A2 describes plastisol compositions comprising a polyaminoamide adhesion promoter and a primary plasticizer, characterized in that a non-ionic secondary plasticizer in the form of solvents is added to the adhesion promoter and the primary plasticizer, and this composition composed of adhesion promoter and of plasticizers is separately mixed before it is also added to the PVC polymer and additives. The solvents used, mention being made of diethylene glycol monoethyl ether (ethyidiglycol) inter alia, are added at from 10 to 70 parts by weight per 100 parts by weight of PVC polymer.

It is an object of the present invention to provide an additive which is intended for polyaminoamide-based adhesion promoters in PVC plastisols and which is compatible with the polyaminoamide, has good effectiveness in diluting the adhesion promoter, and is stable with respect to viscosity, and, finally, has minimum effect on the adhesion of the PVC plastisols to the substrate.

According to the invention, this object is achieved by using adhesion promoters based on polyaminoamides which comprise not only a polyaminoamide but also ethyldiglycol (ethyl Carbitol). The proportion of ethyidiglycol in the polyaminoamide-based adhesion promoter should be at least 10% by weight and at most 60% by weight, preferably from 25 to 55% by weight, particularly preferably from 40 to 50% by weight.

The polyaminoamides used concomitantly according to the invention are obtainable from polymerized fatty acids and, where appropriate, mono- and/or dicarboxylic acids and amine compounds, in particular polyalkylene polyamines via polycondensation, as described below.

The term polymerized fatty acids encompasses polymerized fatty acids which are prepared from unsaturated, natural or synthetic, monobasic, aliphatic acids having from 12 to 22 carbon atoms, preferably 18 carbon atoms. The fatty acids may be polymerized by a well-known process (see, for example, processes in DE 25 06 211 A1).

Polymerized fatty acids whose use is preferred are the commercially available products whose composition is approximately as follows: monomeric acids: from 0.1 to 10%, dimeric acids: from 50 to 98%, trimeric and higher acids: from 1 to 70%.

Dicarboxylic acids which may be used: aliphatic and/or cycloaliphatic, straight-chain or branched acids which have not more than 20 carbon atoms, e.g.: oxalic acid, malonic acid, succinic acid, glutaric acid, adipic acid, pimelic acid, suberic acid, azelaic acid, sebacic acid, trimethyladipic acid, maleic acid and fumaric acid, hexahydrophthalic acid, tetrahydrophthalic acid; or aromatic dicarboxylic acids, e.g. phthalic acid, isophthalic acid, terephthalic acid.

It is preferable to use aliphatic and/or aromatic dicarboxylic acids.

The dicarboxylic acids may be used individually or in a mixture.

These dicarboxylic acids are preferably used in a mixture with the polymeric fatty acids described above. Small amounts of tricarboxylic acids, e.g. trimesic acid, may also be added.

For the condensation process it is preferable to use from 0.5 to 1.0 equivalent of the polymerized fatty acid, from 0.0 to 0.5 equivalent of the dicarboxylic acid, and from 0.2 to 1 mol of polyalkylene polyamine, the total of the equivalents of the polymerized fatty acid and of the dicarboxylic acid here being 1 equivalent.

Preferred polyalkylene polyamines for preparing the polyaminoamides are polyethylene polyamines. Particular preference is given here to polyethylene polyamines having 4 or more nitrogen atoms in the molecule.

The polyaminoamides can be prepared via condensation of the amine compounds with the acid compounds at temperatures up to 280° C. Imidazoline groups also form here. The imidazoline groups form at relatively high temperatures of from about 160 to 280° C. via intramolecular cyclization with elimination of water from the amide groups. Adhesion promoters of this type are commercially available from Huntsman with the trade mark Euretek.

Surprisingly, ethyidiglycol has no adverse effect on the adhesion of the PVC plastisol to the substrate, even in these very large amounts of from 40 to 50% by weight in the adhesion promoter. It would have been expected that the adhesion of the PVC plastisols to the substrate would fall off as the amount of additive in the adhesion promoter rises, because the proportion of the adhesion promoter itself becomes smaller. However, even when the proportion of ethyldiglycol in the adhesion promoter is 50%, there is no, or at least hardly any, effect on the adhesion of the PVC plastisol to the substrate. The viscosity of the adhesion promoters is low, and the adhesion promoter is stable in terms of viscosity.

This invention therefore provides adhesion promoters for PVC plastisols, characterized in that they comprise not only a polyaminoamide but also ethyidiglycol, the amount of ethyidiglycol present in the adhesion promoter, based on the total amount of adhesion promoter, being at least 10% by weight and at most 60% by weight, preferably from 25 to 55% by weight, particularly preferably from 40 to 50% by weight.

The invention also provides a process for the production of coatings and adhesive bonds for materials by applying plastisols based on fine-particle polyvinyl chloride or, respectively, vinyl chloride copolymers, which comprise conventional fillers, additives, plasticizers and adhesion promoters, characterized in that use is made of adhesion promoters which comprise not only a polyaminoamide but also ethyldiglycol in amounts, based on the total amount of adhesion promoter, of at least 10% by weight and at most 60% by weight, preferably from 25 to 55% by weight, particularly preferably from 40 to 50% by weight.

The adhesion promoters according to the invention are added in proportions of from 0.3 to 5% by weight, preferably from 0.5 to 2% by weight, particularly preferably 1% by weight, based on the weight of the plastisol. The proportion of ethyldiglycol in the entire plastisol is thus about 0.03-3%, preferably about 0.5%. After addition of the adhesion promoters of the invention, the plastisol composition is homogenized, and the plastisols thus prepared are stoved on the material at temperatures of 90° C. or above, preferably at from 120° C. to 160° C.

The invention also provides plastisols for the production of coatings on materials, comprising fine-particle polyvinyl chloride or, respectively, vinyl chloride copolymers, conventional plasticizers, fillers, additives and adhesion promoters, characterized in that an adhesion promoter of the invention is present.

### EXAMPLES

In examples 2 to 4 below, the polyaminoamide adhesion promoter Euretek 563 from example 1 is heated with stirring to about 100° C. and the appropriate additives are added, and the mixture is then homogenized.

### Example 1

### Comparative Example

Euretek® 563 (commercial adhesion promoter based on a polyaminoamide from the company Vantico AG).

### Example 2

### Comparative Example

60% Euretek 563; 40% of dioctyl phthalate.

### Example 3

60% Euretek 563; 40% of ethyidiglycol.

### Example 4

### Comparative Example

80% Euretek 563; 20% of glycerol.

Preparation of Plastisols:

1% of the abovementioned polyaminoamide of examples 1 to 4, based on the entire mixture, is added as adhesion promoter to a plastisol composed of: 35% of diisononyl phthalate; 25% of paste PVC (e.g. Solvic® 347 MB); 16.0% of coated chalk (Socal® 312); 16.5% of naturally occurring chalk (Juraperle); 2.0% of CaO; 0.2% of ZnO and 4.3% of Exxsol® 80.

Of course, the adhesion promoters may also be added to conventional plastisol formulations other than those given above in order to obtain the self-adhesive plastisols of the invention.

The adhesion achievable using the plastisols of the invention is determined manually. For this, use is made of Cathoguarol 400 CEC sheets from the company BASF. Dimensions of adherends 25×100 mm.

Method:

A spatula is used to apply a strip of the PVC plastisol, about 1.5 cm in width and about 5 cm in length, to the CEC strip, and a doctor is used to spread the plastisol to give a test strip of width 1.5 cm with a thickness of 1.5 mm. The test specimen is placed in the temperature-controlled drying cabinet and stoved at 140° C. for 30 minutes. After stoving, the test specimen is removed from the drying cabinet. After cooling (for at least 2 hours), the adhesion test can be carried out. For this, a knife is used to make an incision to a width of about 5 cm in both sides of the test strip. The test strip is then tested manually for peelability.

The following classification system is used for assessment:

| | |
|---|---|
| — | No adhesion at all |
| ◯ | Strip can easily be peeled; slight film of plastisol remaining on the |
| | CEC layer |
| ⊕ | Strip difficult to peel; slight film of plastisol remaining on the |
| | CEC layer |
| + | Strip difficult to peel and breaks on peeling; significant film of |
| | plastisol remaining on the CEC layer |
| ++ | Strip cannot be peeled |

The results of the measurements are listed in table 1 below.

TABLE 1

| | | | | Viscosity at 75° C. | Appearance |
|---|---|---|---|---|---|
| | Viscosity**⁾ at | Viscosity at | Manual | [mPa · s] after storage | after storage 30 |
| Example | 25° C. [mPa · s] | 75° C. [mPa · s] | Adhesion | 30 days/50° C. | days/50° C. |
| 1 | n.m*⁾ | 16500 | ++ | 16600 | clear |
| 2 | 22300 | 1300 | + | 6000 | cloudy/ |
| | | | | | incompatible |
| 3 | 4300 | 300 | ++ | 305 | clear |
| 4 | n.m*⁾ | 12000 | ⊕ | 12600 | clear |

*⁾not measurable at 25° C. (viscosity too high).
**⁾The viscosities were measured using a VT 550 Haake rotary viscosimeter in accordance with the manufacturer's instructions.

Interpretation of Results:

As can be seen from the table, the adhesion promoter of the invention (example 3) has very low vicosity and is therefore easy to process. In contrast with comparative example 2, the adhesion promoter of the invention is storage-stable, even after storage at relatively high temperatures, and consequently remains available for use by the user after a prolonged storage time. Surprisingly, use of the inventive adhesion promoters with 40% content of ethyldiglycol, based on the total amount, gives excellent adhesion of the plastisols to the substate (example 3). Use of the adhesion promoter from comparative examples 2, and in particular 4, gives adhesion which is in some cases markedly reduced. The adhesion of the plastisols to the substrates would also have been expected to fall when ethyidiglycol is used in the adhesion promoter, as the proportion of ethyldiglycol rises. Surprisingly, adhesion to the substrate is not reduced and remains good. This result was not foreseeable.

1. An adhesion promoter for plastisols, characterized in that the adhesion promoter comprises not only a polyaminoamide but also at least 10% by weight, and at most 60% by weight, based on the total weight of adhesion promoter, of ethyldiglycol.

2. The adhesion promoter according to claim 1, characterized in that the proportion of ethyldiglycol is from 25% by weight to 55% by weight, based on the total weight of the adhesion promoter.

3-7. (canceled)

8. The adhesion promoter according to claim 1, characterized in that the proportion of ethyldiglycol is from 40% by weight to 50% by weight, based on the total weight of the adhesion promoter.

9. A plastisol composition comprising an adhesion promoter according to claim 1 and fine-particle polyvinyl chloride or vinyl chloride copolymers.

10. The plastisol composition according to claim 9 further comprising conventional plasticizers, fillers, and additives.

11. The plastisol composition according to claim 9 wherein the adhesion promoter is present in an amount of from 0.3% by weight to 5% by weight, based on the weight of the plastisol composition.

12. The plastisol composition according to claim 11, wherein the adhesion promoter is present in an amount of from 0.5% by weight to 2% by weight, based on the weight of the plastisol composition.

13. The plastisol composition according to claim 12, wherein the adhesion promoter is present in an amount of 1% by weight, based on the weight of the plastisol composition.

14. A method for improving the adhesion of a plastisol composition to a substrate by adding to the plastisol composition an adhesion promoter comprising a polyaminoamide and ethyldiglycol wherein the ethyldiglycol is present in the adhesion promoter in an amount of at least 10% by weight and at most 60% by weight, based on the total weight of adhesion promoter.

15. The method of claim 14, wherein the ethyldiglycol is present in the adhesion promoter in an amount of from 25% by weight to 55% by weight, based on the total weight of the adhesion promoter.

16. The method according to claim 14, wherein the adhesion promoter is added in an amount of from 0.3% by weight to 5% by weight, based on the weight of the plastisol composition.

17. A method for coating a substrate comprising the steps of adding an adhesion promoter according to claim 1 to a plastisol composition comprising fine-particle polyvinyl chloride or vinyl chloride copolymers to form a mixture, homogenizing the mixture, applying the mixture to the substrate, and stoving the substrate at a temperature of from 120° C. to 160° C.

18. A process for producing a self-adhesive plastisol by adding an adhesion promoter according to claim 1 to a plastisol composition comprising fine-particle polyvinyl chloride or vinyl chloride copolymers to form a mixture and homogenizing the mixture to form the self-adhesive plastisol.

19. The process according to claim 18 wherein the adhesion promoter is added in an amount of from 0.3% by weight to 5% by weight, based on the weight of the self-adhesive plastisol.
